(19) United States
(12) Patent Application Publication
(10) Pub. No.: US 2012/0050408 A1
(43) Pub. Date: Mar. 1, 2012

(54) TRAPEZOID EJECTION CHIPS FOR MICRO-FLUID APPLICATIONS

(76) Inventors: Jiandong FANG, Lexington, KY (US); Frank E. ANDERSON, Sadieville, KY (US); Bryan D. MCKINLEY, Lexington, KY (US); Richard E. CORLEY, Richmond, KY (US)

(21) Appl. No.: 12/872,215

(22) Filed: Aug. 31, 2010

(51) Int. Cl. B41J 2/145

(52) U.S. Cl. 347/40

(57) ABSTRACT

A micro-fluid ejection head has multiple ejection chips joined adjacently to create a lengthy array across a media to-be-imaged. The chips have fluid firing elements arranged along multiple fluid vias to seamlessly stitch together fluid ejections from different chips. Each of the chips has a shape defining a trapezoid. Adjacent chips are inverted from one to the next across the array. The geometry shortens a distance between same color fluid vias on adjacent chips. The fluid vias may parallel the two parallel sides of the trapezoid or only one non-parallel side. They may all have differing lengths. Same colored vias on adjacent chips may combine together to be equal to the length of fluid vias for other colors. Commonly configured modules define still other embodiments as do frames to seat the modules to define arrays of variable length. Singulating chips from larger wafers provide still further embodiments.

### FIELD OF THE INVENTION

The present invention relates to micro-fluid ejection devices, such as inkjet printers. More particularly, although not exclusively, it relates to ejection heads having multiple ejection chips adjacently joined to create a lengthy micro-fluid ejection array or print swath. Ejection chips with trapezoidal shapes facilitate certain designs.

### BACKGROUND OF THE INVENTION

The art of printing images with micro-fluid technology is relatively well known. A permanent or semi-permanent ejection head has access to a local or remote supply of fluid. The fluid ejects from an ejection zone to a print media in a pattern of pixels corresponding to images being printed. Over time, the fluid drops ejected from heads have become increasingly smaller to increase print resolution. Multiple ejection chips joined together are also known to make lengthy arrays, such as in page-wide printheads.

In lengthy arrays, fluid ejections near boundaries of adjacent chips have been known to cause problems of image “stitching.” Registration needs to occur between fluid drops from adjacent firing elements, but getting them stitched together is difficult when firing elements reside on different substrates. Also, challenges to stitching increase as arrays grow into page-wide dimensions, or larger, since print quality improves as the print zone narrows in width. While some designs have introduced layouts to accommodate this, they have been observed to complicate chip fabrication. They introduce firing elements near terminal ends of chips to align lengthwise with colors shifted laterally by one fluid via on same or adjacent chips. They also reside on complexly shaped substrates.

In other designs, narrow print zones tend to favor narrow ejection chips. Between colors, however, narrow chips leave little room to effectively seal off colors from adjacent colors. There is limited “real estate” to bond chip surfaces to other structures. Narrow chips also have poor mechanical strength, which can cause elevated failure rates during subsequent assembly processes. They also leave limited space for distribution of power, signal and other routing of lines.

With reference to FIG. 1, the assignee of the invention has fairly suggested packaging ejection chips 10 as components of modules 20 for stand-alone or array use. The chips interface electrically with wire bonds 30 to a printed circuit board 40/cable 50 to receive firing and other commands from upstream processors. They mount to a reservoir of fluid through a tile 60 and ceramic base 70. The module fluidically “fans out” the travel of fluid from the chip to the tile to the base. When packaged in lengthy arrays, modules of this type limit distances of closeness and, potentially, imaging performance. It is known to seek fluid flow distances as short as possible to prevent nozzles or firing elements from fluidically “starving,” but shortening distances too greatly limits surface availability for bonding substrates together and sealing-off fluid leaks.

With reference to FIG. 2, “tiling clearances” between bases 70 and “same color plane distances” are labeled for an array of adjacent chips 10 N, 10 N+1 and 10 N+2. On opposing chips, adjacent fluid vias 90−1 having the same color demand exceptionally short distances in page-wide arrays to achieve high quality imaging. While molding/firing tolerances, wall thicknesses, etc. of ceramic bases 70 can vary according to material selection and manufacturer, and those can shrink or widen the required minimum air gap to avoid interference during assembly processes and same color plane distances as the situation dictates, the variables provide little relief in making the same color plane distances measurably shorter.

A need exists to significantly improve conventional ejection chip designs for larger stitched arrays. The need extends not only to improving stitching, but to manufacturing. Additional benefits and alternatives are also sought when devising solutions.

### SUMMARY OF THE INVENTION

The above-mentioned and other problems become solved with trapezoid ejection chips for micro-fluid applications. A micro-fluid ejection head has multiple ejection chips joined adjacently to create a lengthy array across a media to-be-imaged. The chips have fluid firing elements arranged along multiple fluid vias to seamlessly stitch together fluid ejections from different chips. Each of the chips has a planar shape substantially defining a trapezoid. Adjacent chips are inverted from one to the next across the array. A first non-parallel side from one chip and a second non-parallel side from another chip define a parallel gap between two chips. The geometry shortens a distance between same color fluid vias on adjacent chips. In some instances, a separation distance of less than about 1 mm occurs in a direction of media advance transverse to the direction of the array.

Also, fluid vias may parallel the two parallel sides of the trapezoid or only one non-parallel side. They may all have differing lengths or a minority of them may extend in length substantially shorter than a majority each having a substantially common length. In some embodiments, same colored vias on adjacent chips combine together to be substantially equal in length to two other fluid vias on the same chips for other colors despite each via having a different length on a single chip.

Chips packaged in commonly configured modules represent still other embodiments. Modules include fluidic and electrical components for ejecting ink. A shared frame seats the modules in openings to define arrays of variable length. Modular assemblies of this type offer advantages, such as testing individual modules for both electric and fluidic compliance prior to final assembly in a page-wide printhead with other fully tested modules. Singulating chips from larger wafers provide still further embodiments. Dicing lines, etch patterns and techniques are disclosed.

These and other embodiments are set forth in the description below. Their advantages and features will be readily apparent to skilled artisans. The claims set forth particular limitations.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIGS. 1 and 2 are diagrammatic views in accordance with the prior art showing rectangular ejection chips as part of configurable modules in modular arrays;

FIGS. 3-7 are diagrammatic views of micro-fluid ejection heads having ejection chips defining trapezoids, including modular arrays, arrangements of fluid vias and spacing constraints;

FIG. 8 is a diagrammatic view showing frames to commonly mount modules with trapezoid ejection chips; and

FIG. 9 is a diagrammatic view for singulating ejection chips from a wafer.

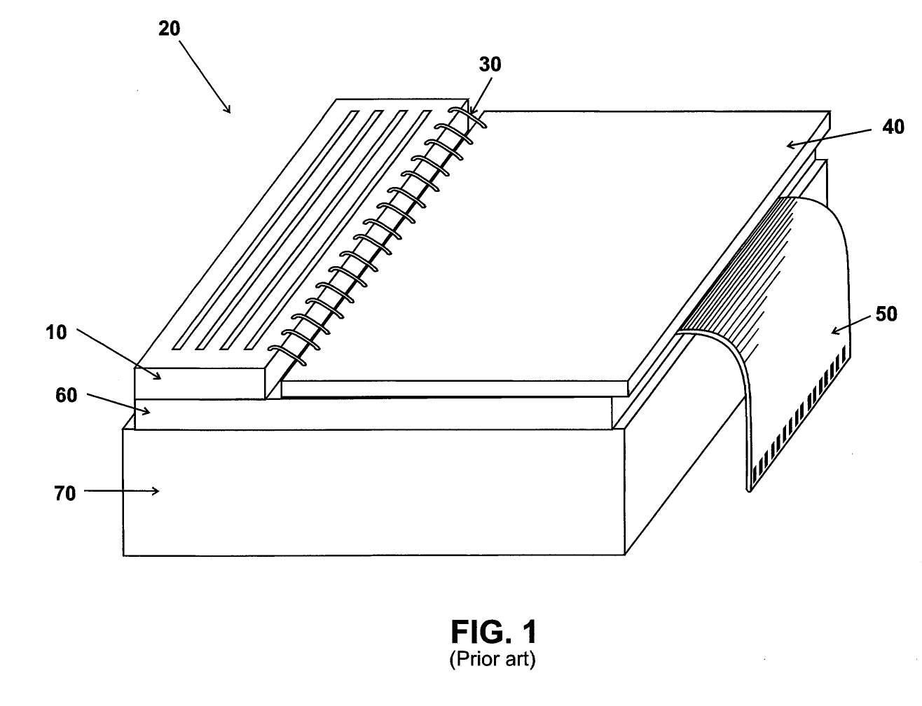

### DETAILED DESCRIPTION OF THE ILLUSTRATED EMBODIMENTS

In the following detailed description, reference is made to the accompanying drawings where like numerals represent like details. The embodiments are described in sufficient detail to enable those skilled in the art to practice the invention. It is to be understood that other embodiments may be utilized and that process, electrical, and mechanical changes, etc., may be made without departing from the scope of the invention. Also, the term wafer or chip includes any base semiconductor structure, such as silicon-on-sapphire (SOS) technology, silicon-on-insulator (SOI) technology, thin film transistor (TFT) technology, doped and undoped semiconductors, epitaxial layers of silicon supported by a base semiconductor structure, as well as other semiconductor structures hereafter devised or already known in the art. The following detailed description, therefore, is not to be taken in a limiting sense and the scope of the invention is defined only by the appended claims and their equivalents. In accordance with the present invention, methods and apparatus include ejection chips for a micro-fluid ejection head, such as an inkjet printhead.

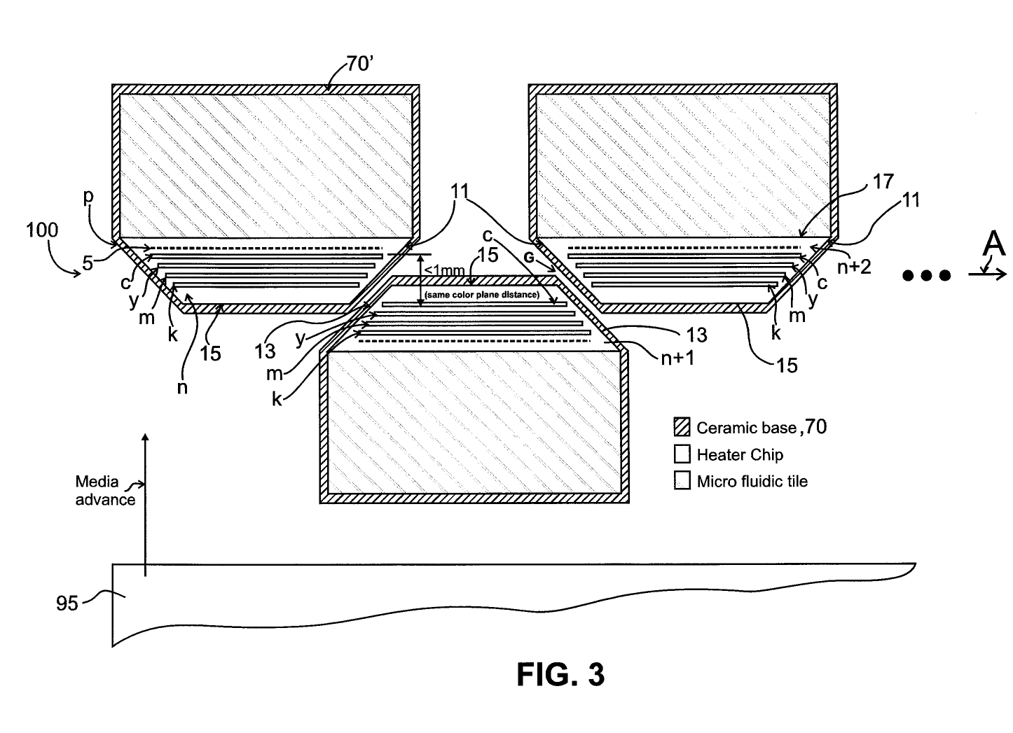

With reference to FIG. 3, plural ejection chips n, n+1, n+2 . . . are configured adjacently in a direction (A) across a media to-be-imaged 95. The micro-fluid array 100 includes as few as two chips, but as many as necessary to form a complete array. The array typifies variability in length, but two inches or more are common distances depending upon application. Arrays of 8.5″ or more are contemplated for imaging page-wide media in a single printing pass. The arrays can be used in micro-fluid ejection devices, e.g., printers, copiers, medical devices, etc., having either stationary or scanning ejection heads. The media advances past the chips in an imaging device in a direction transverse to the array length.

Each chip includes pluralities of fluid firing elements (shown as a few darkened circles 5 representing nozzle shapes). The elements are any of a variety, but contemplate resistive heaters, piezoelectric transducers, or the like. They are formed on the chip through a series of growth, patterning, deposition, evaporation, sputtering, photolithography or other techniques. They have spacing along an ink via to eject fluid from the chip at times pursuant to commands of a printer microprocessor or other controller. The timing corresponds to a pattern of pixels of the image being printed on the media. The color of fluid corresponds to the source of ink, such as those labeled c (cyan), m (magenta), y (yellow), and k (black).

The planar shape of the chip typifies a trapezoid. It has two parallel sides and two non-parallel sides. An underlying base 70′ supports a single one of the ejection chips offset from a center near a periphery (P) having a shape similar to the trapezoid. Three sides of the periphery substantially mirror the two non-parallel sides and short parallel side of the trapezoid. In either the chip or the base, the angles between the parallel and non-parallel sides can vary. They can also be different from one side to the next. As seen, a forty-five degree angle extends on both ends between the long parallel side and the non-parallel sides. The design typifies an isosceles trapezoid.

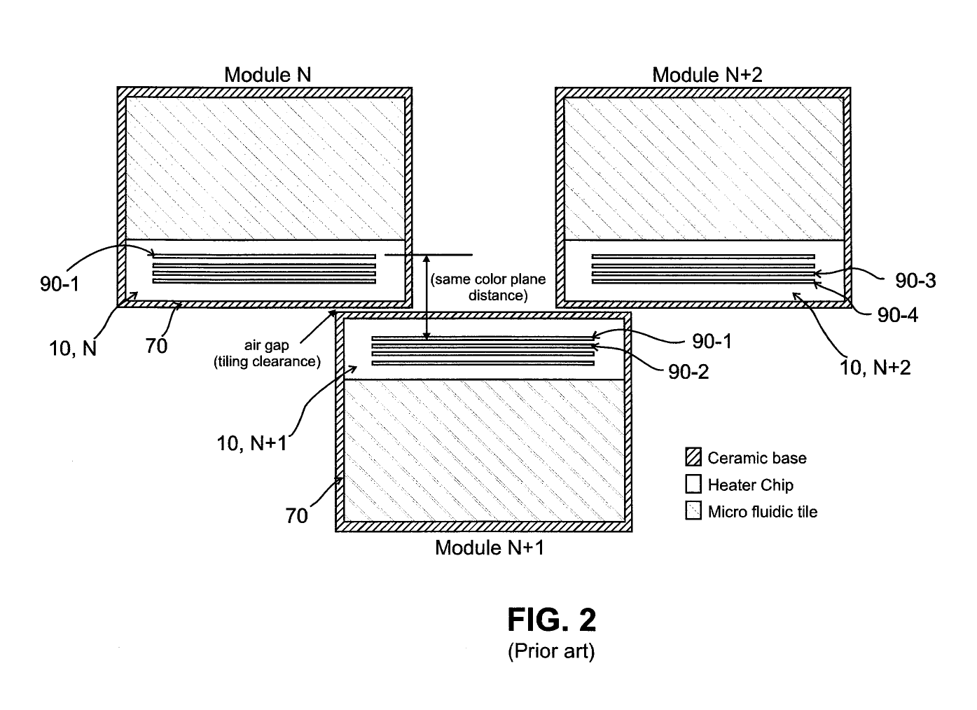

The orientation of each chip is inverted from one to the next across the array. A first non-parallel side 11 from one chip (n) and a second non-parallel side 13 from another chip (n+1) define a parallel gap G between the two chips. The geometry is such that the chips can be inched toward one another along this gap. It shortens a distance between same color fluid vias on adjacent chips (“same color plane distance”). In some instances, a separation distance of less than about 1 mm is obtained in the direction of media advance. This represents a substantial space savings over the prior art “same color plane distance” which can be as great as 3.5 mm or more in FIG. 2.

Skilled artisans will also note the arrangement of fluid vias. On any given chip, each via has a different length. The closer the via resides to the shortest parallel side 15 of the trapezoid, the shorter its length. Conversely, the closer the via resides to the longest parallel side 17, the longer its length. Across any two adjacent chips, the combined length of the vias per a common color is substantially the same as every other color on the same chips. That is, the cyan (c) fluid via on ejection chip n and the cyan fluid via on ejection chip n+1 have a combined length in the direction of the array that is substantially equal to the combined length of the two fluid vias for any of magenta, yellow or black. This is possible because every other chip has fluid vias positioned in a same order, while intervening chips position them in an opposite order. On chips n and n+2, for example, fluid vias cyan, yellow, magenta, and black are arranged from longest to shortest via length. Chip n+1, on the other hand, has fluid vias cyan, yellow, magenta, and black arranged from shortest to longest via length. Ultimately, the fluid vias across an entire array are essentially the same distance for all colors. This completes a full color imaging array having no gaps in imaging coverage.

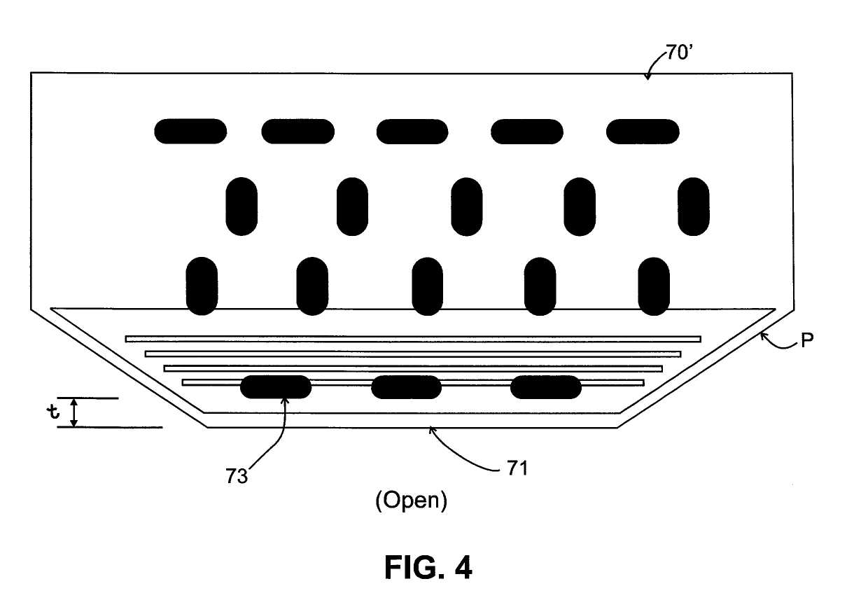

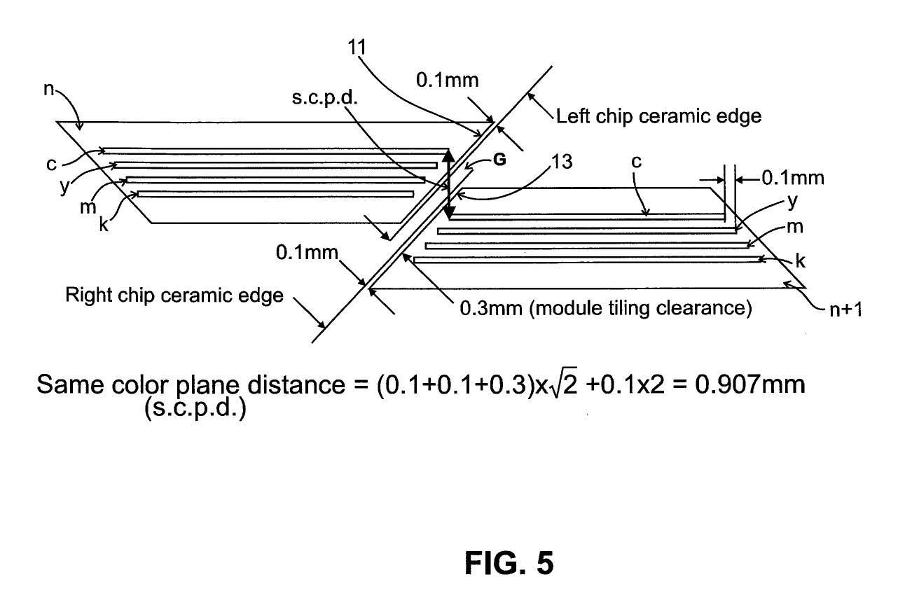

With reference to FIG. 4, the layout of trapezoid ejection chips on a base 70′ prevents dimension constraints on the tiling edge 71. Since the tiling edge faces a relatively unencumbered area (“open”) of the array, the wall thickness t from the leading edge to fluid holes 73 no longer sets an artificial constraint. There are no constraining “air gaps” for the bases 70 that are encountered when placing chips together in the array of FIG. 2. Instead, the bases 70′ of the present design can push slightly into the open area thereby freeing constraints on wall thicknesses to readily satisfy manufacturing requirements of modern dry pressing technology for ceramic molding. Further dimensions are seen in FIG. 5.

With reference to the figure, the ejection chips n, n+1 of the array include a first distance from a non-parallel side of the trapezoid 11, 13 to a chip ceramic (base) edge. In this view, the distance is 0.1 mm. The array includes a second distance for “module tiling clearance” between the left and right ceramic edges. In this view, the distance is 0.3 mm. In a third distance, a terminal edge from one fluid via to a terminal edge of an adjacent fluid is 0.1 mm. By applying simple geometry, a same color plane distance (s.c.p.d.) can be calculated in the direction of media advance for the length between two fluid vias on adjacent chips having a same color. As seen, the s.c.p.d. is 0.907 mm between the two cyan (c) vias. Similarly, the s.c.p.d is 0.907 mm between the yellow y, magenta m and back k vias on the two chips. In other embodiments, the same color plane distance reaches as much as 2 mm when the width at terminal edges increases to about 0.646 mm. This represents but one upper limit of a representative range. To sustain high mechanical strength the width at the terminal edges should reside in a range closer to about 0.05 to 1 mm.

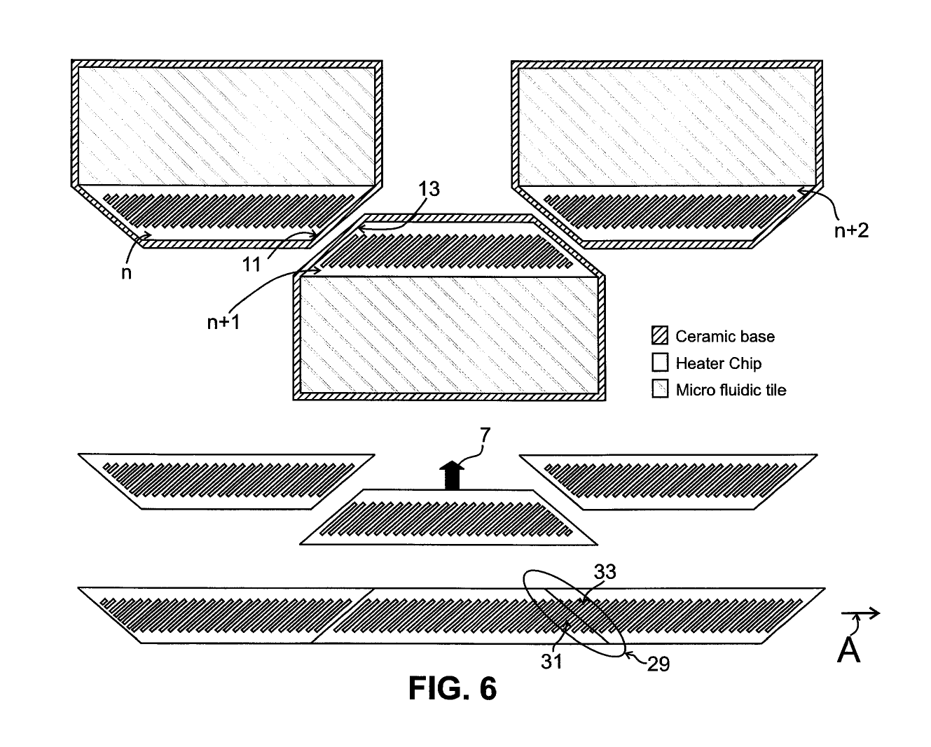

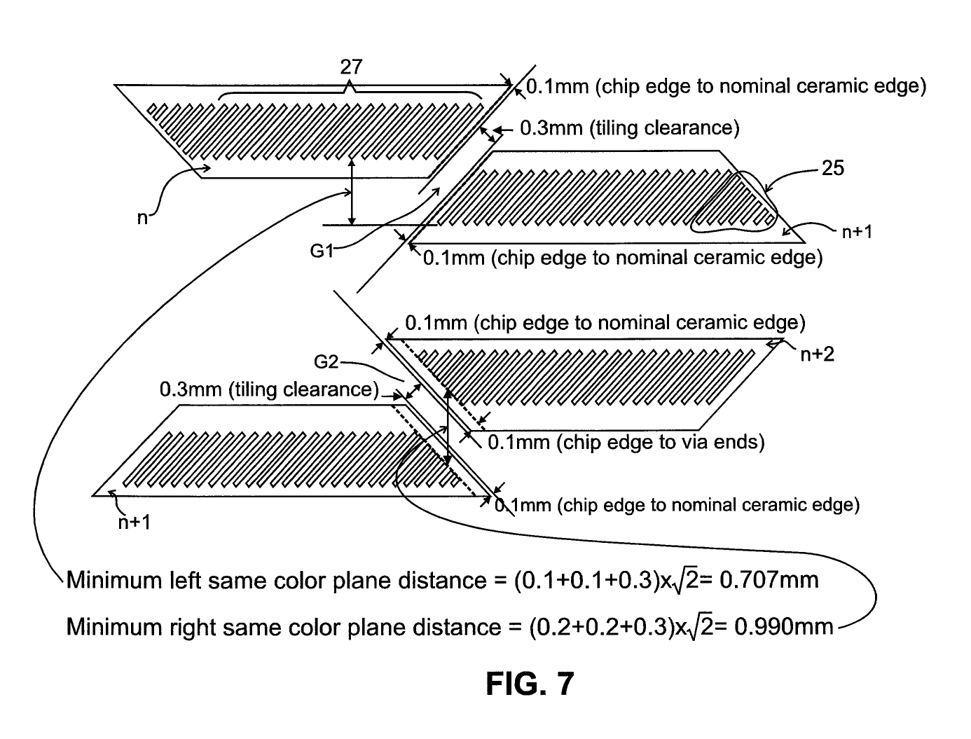

With reference to FIGS. 6 and 7, skilled artisans will appreciate that trapezoid ejection chips are not limited to fluid vias extending laterally across the array. Rather, the vias can have alternate orientations, such as extending angularly relative to the array direction. In one embodiment, this consists of fluid vias paralleling but a single non-parallel side of the trapezoid 11 or 13. They may also have a minority number 25 of vias extending in length substantially shorter than a majority number 27 of vias each having a substantially common length. In this way, each chip uses symmetrical amounts of space on both sides of the trapezoid. It also allows adjacent chips to push closely to one another (in the direction of the arrow 7) so that all the vias extending the length of the array in the direction (A) essentially provide a plurality of vias having a common length for image stitching. This includes vias in the region 29 matching up with one another according to color from one chip to the next to provide a singularly long via. A first portion 31 of a via is likely relatively short on one chip in this region while a mating portion 33 is relatively long on the next chip.

With reference to FIG. 7, the actual spacing constraints for one embodiment of the design are given. They include nominal distances and calculations of “same color plane distances” between left and right adjoining chips. The chips can be made closer to one another when via lengths are longer at the boundary gap G1 between the chips, e.g., between chips n and n+1. The chips are further away when the via lengths are shorter at the boundary gap G2, e.g., between chips n+1 and n+2. The dotted lines indicate the seamless stitching boundary that occurs when all ejection chips are leveled in a single line in the direction (A). For a more complete discussion on particular angles of fluid vias, via spacing, via length, printing resolution, nozzle redundancy, and the like, reference is made to the Applicant's co-pending application U.S. Ser. No. 12/788,446, filed May 27, 2010, entitled “Skewed Nozzle Arrays on Ejection Chips for Micro-Fluid Applications.” The subject matter of the application is incorporated herein by reference.

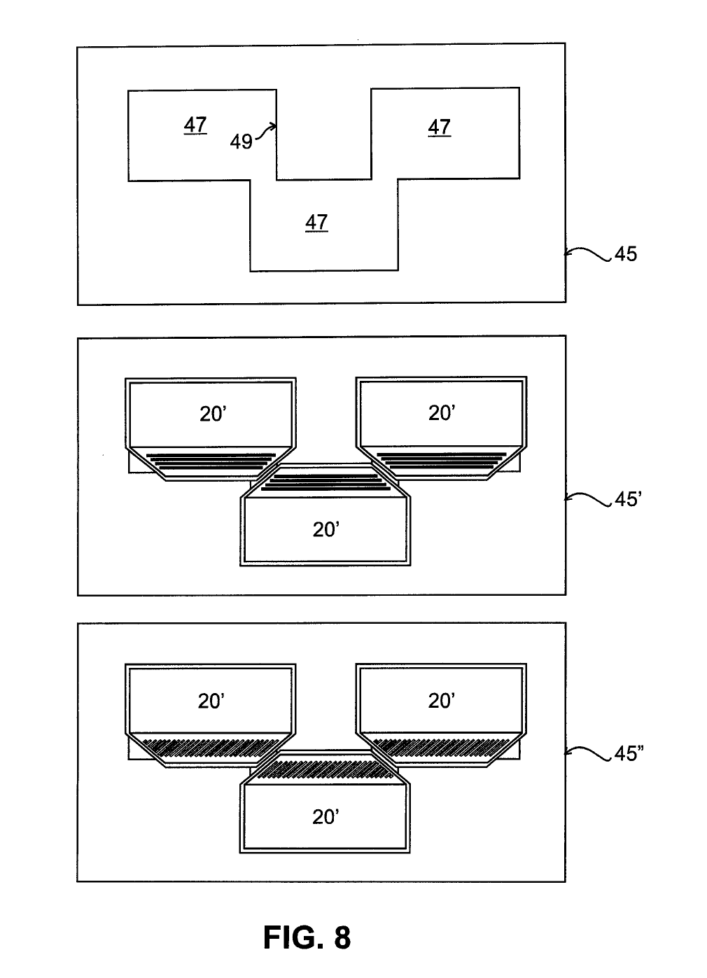

With reference to FIG. 8, a frame 45 has openings 47. The openings receive commonly configured modules 20′ to singularly mount the ejection chips in a lengthy array. Depending upon the number of openings, the array length can increase or decrease. The number can be as small as one or as great as ten or more. The length varies from an inch to 8.5 inches or more. The chips have either fluid vias paralleling the length of the array as in frame 45′ or vias angled to the length of the array as in frame 45″. Adhesives are applied on the base of the modules, on a surface of the frame, or both, to secure the chips in place.

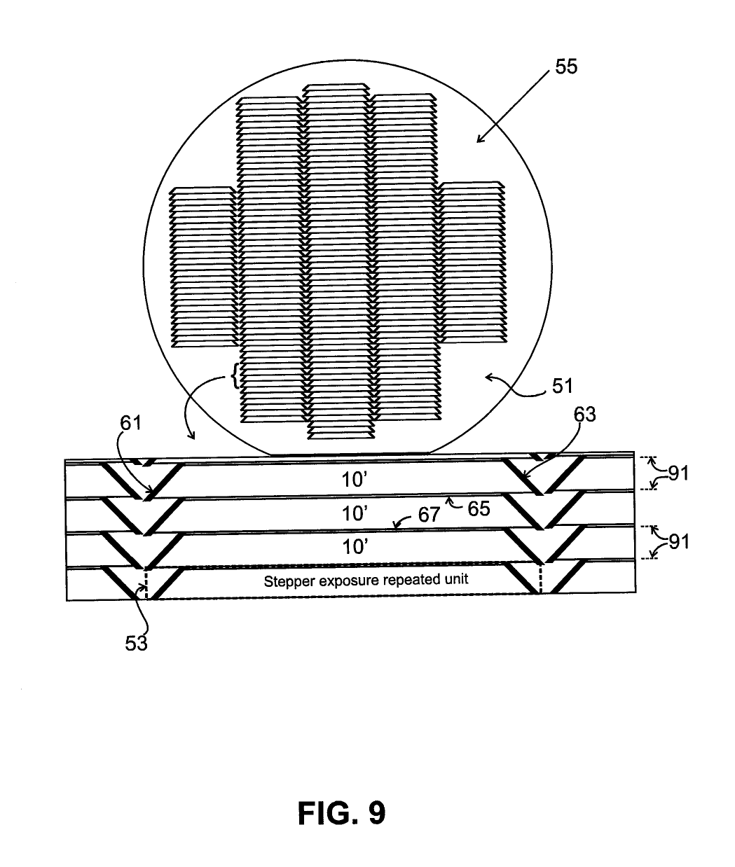

The frame is selected to exist compatibly with the adhesives and to provide mechanical support. The support is sufficient to facilitate alignment and registration of one module to a next and to withstand mechanical forces over a lifetime of imaging without substantially deforming. Also, lightweight materials provide advantage in imaging devices scanning the ejection chips back-and-forth over a media. The lighter the material, the easier it is for the imaging device to move the frame. Cost is still another consideration as is an operating temperature of the imaging device. Representative frame materials include aluminum, plastic, composites, or the like. A suitable prototype has been made of acrylonitrile butadiene styrene (ABS) by injection molding and it has been shown to demonstrate sufficient characteristics for use in imaging devices. The prototype has been even shown to exhibit high mechanical strength to support modules in the fragile cantilever region 49 of the frame. With reference to FIG. 9, a wafer 51 includes pluralities of ejection chips 10′ for singulating. The singulating includes methods to achieve high yields with much higher fragility than conventional chips. For a single crystal silicon wafer, cracks favor propagation along crystal planes, especially <111> crystal planes. Thus, a preferred wafer for processing is a <100> silicon wafer. It may typify p-type having a resistivity of 5-20 ohm/cm. Its beginning thickness can range from about 200 to 800 microns or other.

Trapezoidal shaped ejection chips are fabricated with traditional stepper exposures. Chips enclosed in rectangles 53 (dashed lines) are laid out on the wafer in a grid pattern 55. The two non-parallel sides 61, 63 of each chip are etched by DRIE (deep reactive ion etching) or other processes at a same time of etching the fluid vias (not shown here) without extra costs. The wafer is mechanically diced at the lowest cost to individual chips along horizontal lines 91 that define the two parallel sides 65, 67 of the trapezoidal ejection chips.

Relatively apparent advantages of the many embodiments include, but are not limited to: (1) trapezoidal chips having very closely positioned fluid vias of a same color for use in lengthy arrays; (2) chips facilitating close tiling of printhead modules; (3) chips eliminating constraints on wall thickness dimensions of a tiling edge of an underlying base; (4) modular assembly; and (5) high-yield wafers with relatively cost effective manufacturing.

The foregoing has been presented for purposes of illustrating the various aspects of the invention. It is not intended to be exhaustive or to limit the claims. Rather, it is chosen to provide the best illustration of the principles of the invention and its practical application to enable one of ordinary skill in the art to utilize the invention, including its various modifications that naturally follow. All such modifications and variations are contemplated within the scope of the invention as determined by the appended claims. Relatively apparent modifications include combining one or more features of various embodiments with one another.

1. A micro-fluid ejection head, comprising:
a plurality of ejection chips configured adjacently across a media to-be-imaged to create in a first direction a lengthy micro-fluid array, each chip having pluralities of firing elements that are configured along multiple fluid vias, a planar shape of ones of the ejection chips substantially defining a trapezoid.

2. The ejection head of claim 1, wherein the trapezoid for said each said includes two non-parallel sides, a first non-parallel side from one ejection chip and a second non-parallel side from a second ejection chip defining a substantially parallel gap between said one and second ejection chips.

3. The ejection head of claim 1, wherein each of the multiple fluid vias extends a different length across said each chip.

4. The ejection head of claim 1, wherein a single fluid via on a first ejection chip and a second fluid via on a second ejection chip having a same fluid color and a different length together combine in length to be substantially equal to other combined said fluid vias on the first and second ejection chips for another said fluid color.

5. The ejection head of claim 1, wherein a first fluid via on a first ejection chip and a second fluid via on a second ejection chip having a same fluid color have a separation distance of less than about 1 mm in a direction of media advance transverse to the first direction.

6. The ejection head of claim 1, wherein orientations of the trapezoids are substantially inverted from one to another of said ejection chips across the lengthy micro-fluid array in the first direction.

7. The ejection head of claim 1, further including a module for mounting said ones of the ejection chips.

8. The ejection head of claim 7, wherein each said module includes a ceramic base supporting a single one of the ejection chips offset from a center near a periphery having a shape similar to said trapezoid.

9. The ejection head of claim 7, wherein each said module is arranged a same as every other said module.

10. The ejection head of claim 7, further including a frame having openings for commonly mounting all said modules to define said lengthy micro-fluid array in said first direction.

11. The ejection head of claim 1, wherein said trapezoid for said each chip includes two parallel and two non-parallel sides, each of the multiple fluid vias extending substantially parallel to the two parallel sides.

12. The ejection head of claim 11, wherein said each of the multiple fluid vias has a different length.

13. The ejection head of claim 1, wherein said trapezoid for said each chip includes two parallel and two non-parallel sides, each of the multiple fluid vias extending substantially parallel to only a single one of the two non-parallel sides.

14. The ejection head of claim 13, wherein a minority of the multiple fluid vias extend in length substantially shorter than a majority of the multiple fluid vias each having a substantially common length.

15. A micro-fluid ejection head, comprising:
a plurality of ejection chips configured adjacently across a media to-be-imaged to create in a first direction a lengthy micro-fluid array, each chip having pluralities of firing elements configured along multiple fluid vias, a planar shape of ones of the ejection chips substantially defining a trapezoid of which two sides are non-parallel sides and two sides are parallel sides, a first non-parallel side of one ejection chip and a second non-parallel side of a second ejection chip defining a gap between any two said ejection chips.

16. The ejection head of claim 15, wherein orientations of the ejection chips are substantially inverted from one another in the planar shape of every other ejection chip of the adjacently configured ejection chips in the first direction across the lengthy micro-fluid array.

17. The ejection head of claim 15, wherein each of the multiple fluid vias extends a different length across said each chip.

18. The ejection head of claim 17, wherein a single fluid via on a first ejection chip and a second fluid via on a second ejection chip having a same fluid color together combine in length to be substantially equal to other combined said fluid vias on the first and second ejection chips for another said fluid color.

19. The ejection head of claim 15, further including a single frame for commonly mounting all said ejection chips to define said lengthy micro-fluid array in said first direction.

20. A micro-fluid ejection head, comprising:
a plurality of ejection chips configured adjacently across a media to-be-imaged to create in a first direction a lengthy micro-fluid array, each chip having multiple fluid vias of differing length extending across a planar shape of ones of the ejection chips substantially defining a trapezoid; and
a frame to commonly mount all said ejection chips, wherein orientations of the ejection chips are substantially inverted from one ejection chip to a next ejection chip in the first direction across the lengthy micro-fluid array such that the planar shape for said trapezoid for said each chip includes two non-parallel sides wherein a first non-parallel side from one ejection chip and a second non-parallel side from a second ejection chip defines a substantially parallel gap between any two said ejection chips mounted in the frame.
